(19) United States
(12) Patent Application Publication
(10) Pub. No.: US 2019/0139052 A1
(43) Pub. Date: May 9, 2019

(54) PAYMENT AUTHORIZATION SYSTEM

(71) Applicant: PayPal, Inc., San Jose, CA (US)

(72) Inventors: German Carlos SCIPIONI, San Jose, CA (US); Byong Mok Oh, San Jose, CA (US)

(21) Appl. No.: 16/124,741

(22) Filed: Sep. 7, 2018

Related U.S. Application Data
(63) Continuation of application No. 13/538,531, filed on Jun. 29, 2012, now abandoned.

(51) Int. Cl. G06Q 20/42; G06Q 20/32

(52) U.S. Cl. CPC G06Q 20/42; G06Q 20/322

(57) ABSTRACT

A payment authorization system includes an account database associating a first user device and a payment account. A system provider device in the payment authorization system is coupled to a network and the account database. The system provider device is operable to receive a payment request from a second user device over the network to make a payment using the payment account. In response to receiving the payment request, the system provider device sends an authorization request to the first user device over the network. In response to receiving an authorization from the first user device over the network, the system provider device sends an instruction over the network to make a payment according to the payment request. The first user device may designate the second user device for using the payment account such that a temporary security code is sent to the second user device over the network.

### CROSS REFERENCED TO RELATED APPLICATIONS

This application is a continuation of U.S. patent application Ser. No. 13/538,531, filed on Jun. 29, 2012, the contents of which are incorporated by reference in its entirety.

### BACKGROUND

### Field of the Invention

The present invention generally relates to online and/or mobile payments and more particularly to a payment authorization system for use in making online and/or mobile payments.

### Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Conventional online and/or mobile payments include a user selecting items (e.g., products, services, etc.) to purchase from a merchant using their user device, the user designating their user payment account using the user device, the user providing a security code (e.g., a Personal Identification Number (PIN)) for their user payment account using the user device, and the user using the user device to send that information to a payment service provider or account provider such that funds are transferred from the user account to a merchant account in order to pay for the items. Such online and/or mobile payments are limited in that there is a one-to-one relationship between the user, user device, and user payment account, i.e., only the user may use their user device to make payments with their user payment account.

Thus, there is a need for an improved online and/or mobile payment system.

### SUMMARY

According to one embodiment, a method for payment authorization includes associating a first user device and a payment account in a database. A payment request to make a payment using the payment account may then be generated and sent by a second user device. An authorization request is then sent to the first user device and, upon receiving an authorization from the first user device in response to the authorization request, an instruction is sent to make a payment using the payment account.

In some embodiments, prior to the second user device sending the payment request, the first user device may send a designation of the second user device to use the payment account such that the second user device is then associated with the payment account in the database. That designation of the second user device may include a payment constraint that will be checked against the payment request to determine whether the payment request complies with the payment constraint before sending the instruction to make the payment. In another embodiment, the authorization from the first user device may include a security code that is input on the first user device. In another embodiment, in response to receiving the authorization from the first user device, the second user device may be required to enter a security code before the instruction to make the payment will be sent.

As a result, a user having a payment account may authorize that payment account to be used by other users that aren't typically associated with that payment account, or a user that is not associated with a payment account may quickly request and receive authorization from a user associated with that payment account to make a payment. This increases the ease of use and sharing of payments accounts while still ensuring security of those payment accounts against unauthorized uses.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flow chart illustrating an embodiment of a method for payment authorization;

FIG. 2 is a front view illustrating an embodiment of a first user device being used to designate a second user device with a payment account;

FIG. 3 is a front view illustrating an embodiment of a second user device receiving a security code for making payment requests with a payment account;

FIG. 4a is a front view illustrating an embodiment of a first user device and a second user device, with the second user device being used to may a payment request with a payment account associated with the first user device;

FIG. 4b is a front view illustrating an embodiment of a first user device and a second user device, with the first user device being used to authorize the second user device to make a payment with a payment account associated with the first user device;

FIG. 4c is a front view illustrating an embodiment of a first user device and a second user device, with the first user device being used to authorize the second user device to make a payment with a payment account associated with the first user device by providing a security code;

FIG. 4d is a front view illustrating an embodiment of a first user device and a second user device, with the second user device being used to provide a security code to use a payment account associated with the first user device;

FIG. 4e is a front view illustrating an embodiment of a first user device and a second user device being provided confirmations upon a payment being made using a payment account associated with the first user device;

FIG. 5 is a schematic view illustrating an embodiment of a networked system;

FIG. 6 is a perspective view illustrating an embodiment of a user device;

FIG. 7 is a schematic view illustrating an embodiment of a computer system; and

FIG. 8 is a schematic view illustrating an embodiment of a payment authorization system device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for payment authorization of payments requested by a second user device using a payment account that is associated with a first user device. The payment account may only be associated only with the first payer device in a database. The second user device may then be used to send a payment request to make a payment using the payment account. In response, an authorization request is sent to the first payment device. The first user device is then used to send an authorization that may include inputting a security code for the payment account into the first user device, and in response to receiving the authorization, an instruction is sent to make a payment according to the payment request such that the user of the second user device can make a purchase using the payment account associated with the first user device.

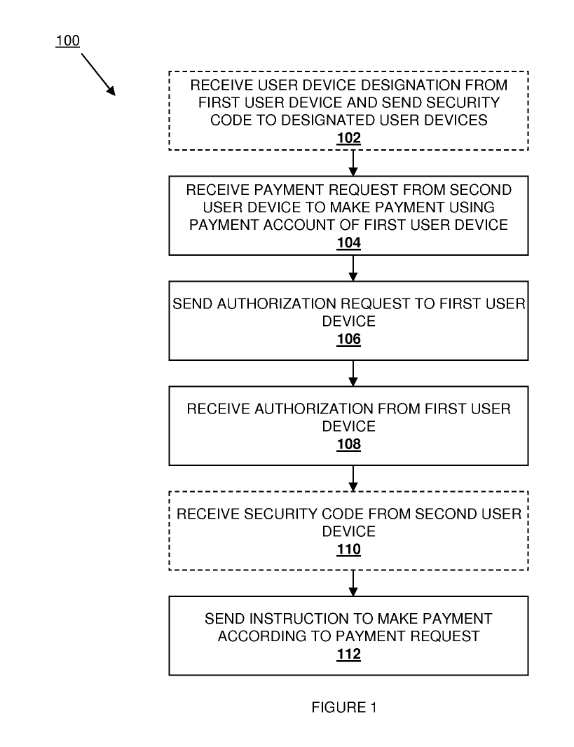

Referring now to FIGS. 1, 2, and 3, a method 100 for payment authorization is illustrated. In some of the embodiments of the method 100 described below, an account provider provides a first user with a payment account, and the payment account may be used to fund payments for purchases made from payees. Furthermore, in some embodiments, a payment service provider such as, for example, PayPal, Inc. of San Jose, Calif., assists in the making of payments from the payment account to the payee by sending instructions to transfer funds from the payment account to a payee account of the payee. However, these embodiments are meant to be merely exemplary, and one of skill in the art will recognize that a variety of modifications may be made to the payment authorization system discussed below without departing from the scope of the present disclosure.

As will be discussed in further detail below, the payment account is associated with a first user and a first user device in a database, which allows the first user to use the first user device to make payments using the payment account. Furthermore, a second user includes a second user device that is either not associated with the payment account in the database, or not initially associated with the payment account in the database until the performance of the method of the present disclosure. While only one second user device is illustrated and described in some of the embodiments below, the system and method may include any number of second user devices that may be used, along with the first user device, to make payments using the payment account as discussed below.

In some embodiments, the method 100 may begin at optional block 102 where one or more user device designations are received from a first user device, and a security code is sent to the designated user devices. As discussed in further detail below, block 102 of the method 100 is optional in that, in some embodiments, the first user need not be aware of, and thus the first user device 200 need not designate beforehand, second user devices for using the payment account of the first user prior to those second user devices attempting to user the payment account. In the embodiment including optional blocks 102 and 110 illustrated and described below, the first user device designates a single second user device and a security code is sent to that second user device. However, one of skill in the art will recognize that the first user may designated any number of second user devices, and one or more security codes may be sent to those second user devices without departing from the scope of the present disclosure.

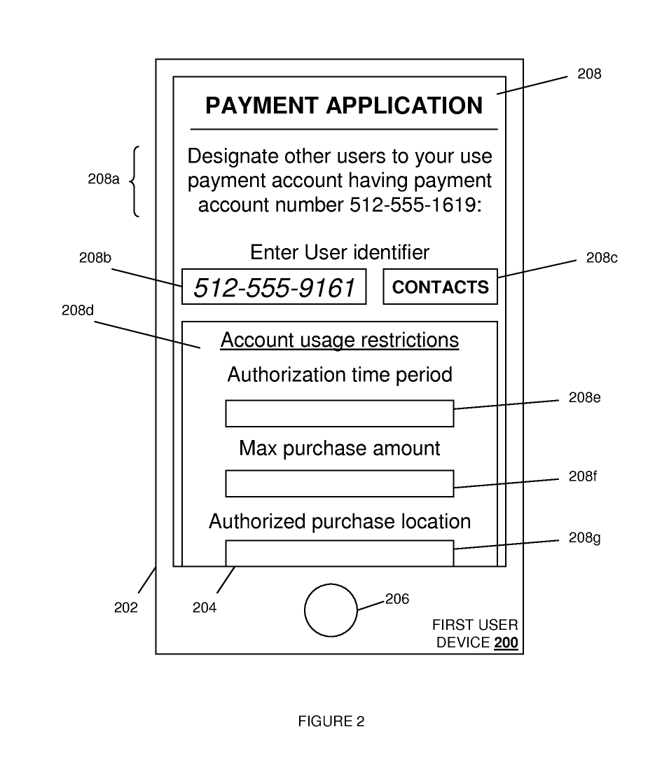

Referring now to FIG. 2, a first user device 200 is illustrated that includes a chassis 202, a display 204 located on the chassis 202, and an input button 206 located on the chassis 202 and spaced apart from the display 204. While the first user device 200 is illustrated and described below as a mobile phone, one of skill in the art will recognize that the first user device 200 may be a laptop computer, a tablet computer, a desktop computer, and/or a variety of mobile and/or non-mobile computing devices known in the art.

At block 102 of the method 100, the first user device 200 may be operated in order to display a user device designation page 208 on the display 204. In an embodiment, the user device designation page 208 may be provided as a web page on a website operated by an account holder device, a payment provider device, and/or any other payment authorization system provider device. Thus, at block 102, the first user device 200 is operated to receive the user device designation page 208 over a network from the payment authorization system provider device. In another embodiment, the user device designation page 208 may be provided as an application stored on and operated by the first user device 200. Thus, at block 102, the first user device 200 is operated to launch the application that displays the user device designation page 208. In the embodiment illustrated in FIG. 2, the first user may have previously provided any necessary user name, password, and/or other security information necessary to access their payment account such that user devices may be designated at block 102.

The user device designation page 208 includes a user device designation instruction 208a including details such as a payment account number (e.g., the first user device phone number in the illustrated embodiment) that is associated with the first user and/or the first user device 200 and with which designated user devices will be designated for. The user device designation page 208 also includes a user device input box 208b in which the first user may provide user device identifiers to designate user devices (e.g., a second user device phone number in the illustrated embodiment). The user device designation page 208 also include a user device search button 208c that the first user may use to search for user devices to designate (e.g., the “CONTACTS” button that the first user may select in order to search through their contacts to find second user device phone numbers to designate). The user device designation page 208 also includes a payment constraint section 208d that the first user may use to put payment constraints on any purchases attempt by a designated user device using the payment account. For example, the first user may input a time period into a time period payment constraint input box 208e to limit the amount of time the designated user device may make purchases using the payment account, an amount into an amount payment constraint input box 208f to limit the amount of the purchase the designated user device may make using the payment account, a location into a location constraint input box 208g to limit the locations in which the designated user device may make purchases using the payment account, and/or a variety of other payment constraints known in the art. Upon providing a user device identifier in the user device input box 208b, and in some embodiments payment constraints in the payment constraint section 208d, the first user may operate the first user device 200 to send that information over a network to a payment authorization system provider device (e.g., using a “submit” button (not illustrated) provided on the user device designation page 208.)

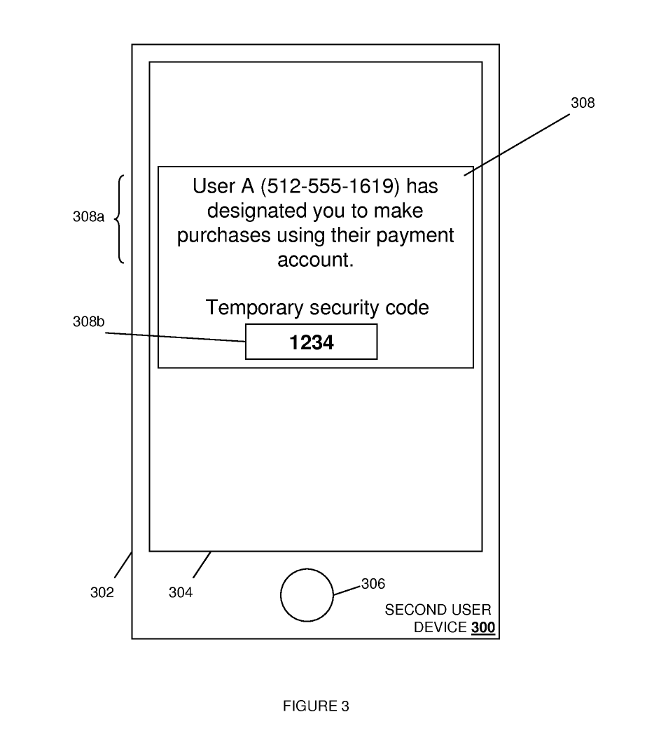

Referring now to FIG. 3, a second user device 300 is illustrated that includes a chassis 302, a display 304 located on the chassis 302, and an input button 306 located on the chassis 302 and spaced apart from the display 304. While the second user device 300 is illustrated and described below as a mobile phone, one of skill in the art will recognize that the second user device 300 may be a laptop computer, a tablet computer, a desktop computer, and/or a variety of mobile and/or non-mobile computing devices known in the art.

At block 102 of the method 100, in response the designation of the second user device 300 over the network, the payment authorization system provider device may generate a security code and send that security code over the network to the second user device 300. In the illustrated embodiment, the second user device 300 is displaying a designation alert 308 on the display 304 that was sent over the network from the payment authorization system provider device. In an embodiment, the designation alert 308 may include a text message, a pop-up window, an alert in an application, a web page, and/or a variety of other alerts known in the art. The designation alert 308 includes designation information 308a explaining to the second user of the second user device 300 that the first user has designated the second user to make payments using a payment account associated with the first user and first user device 200. The designation alert 308 also includes a security code 308b that the second user may use to authorize payments using the payment account of the first user, discussed in further detail below. In the illustrated embodiment, the security code 308b is a temporary security code that may expire after a period of time. In some embodiments, the security code 308b may not be temporary (e.g., the security code 308b may remain active until the first user sends an instruction to deactivate the security code 308b.)

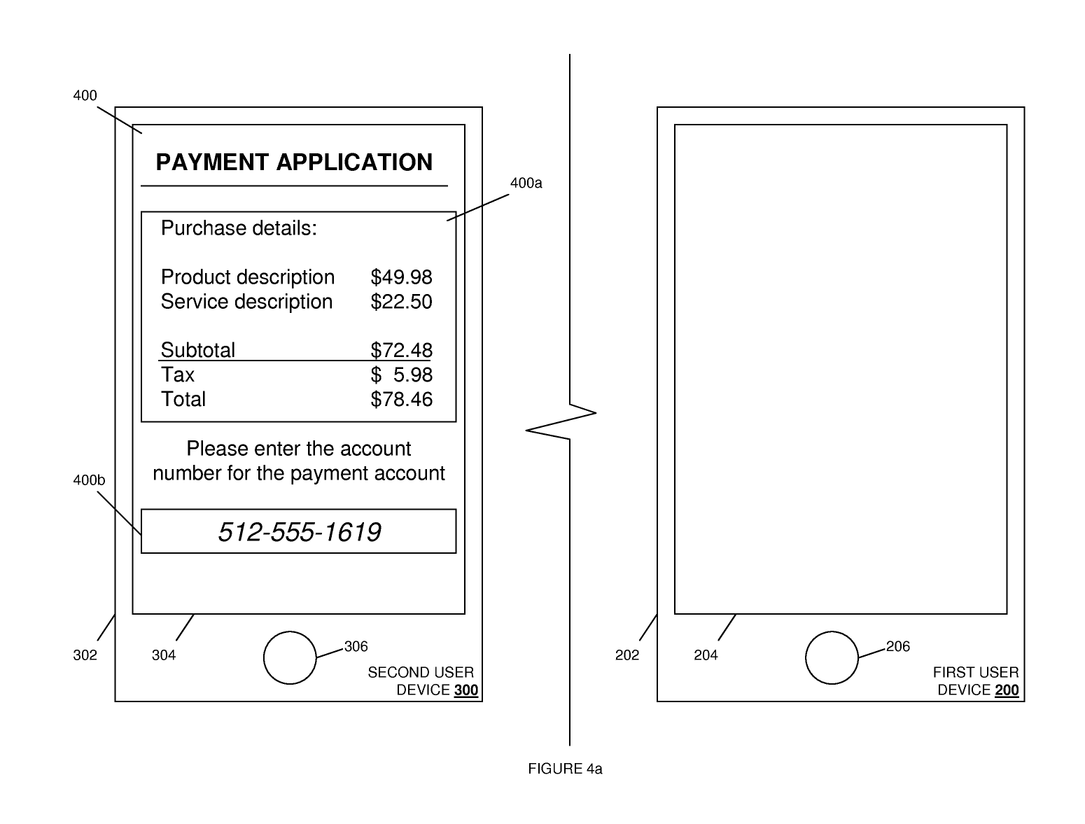

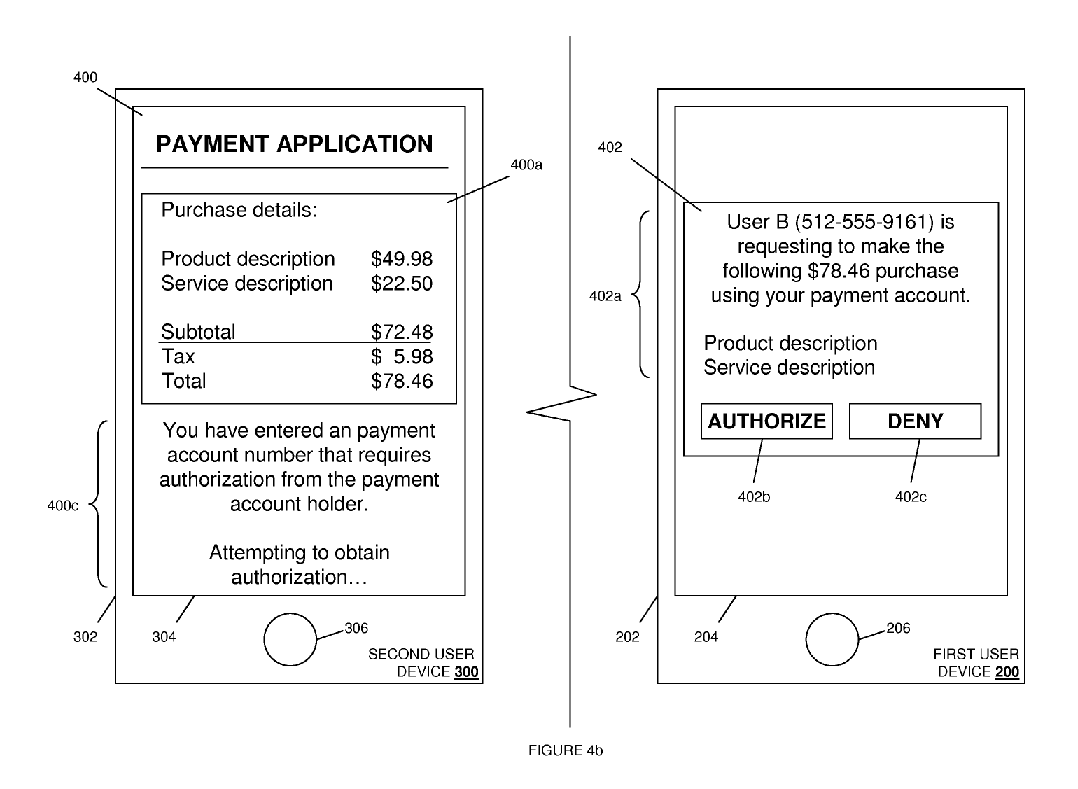

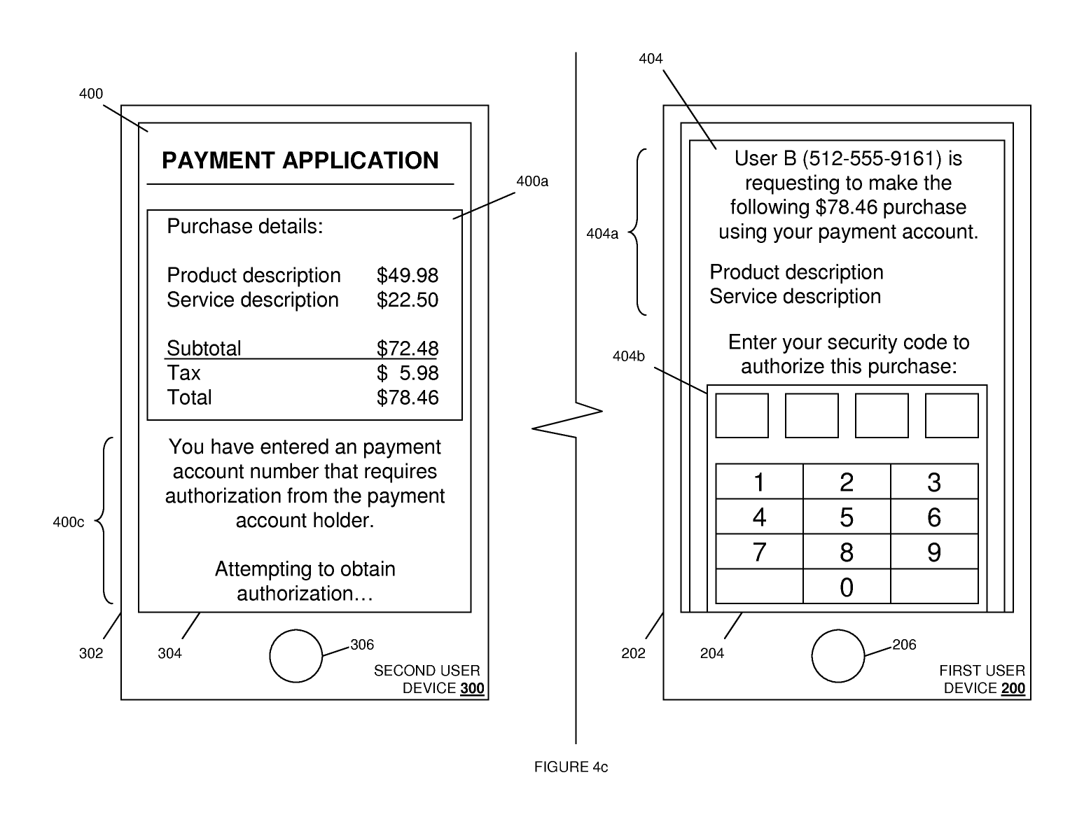

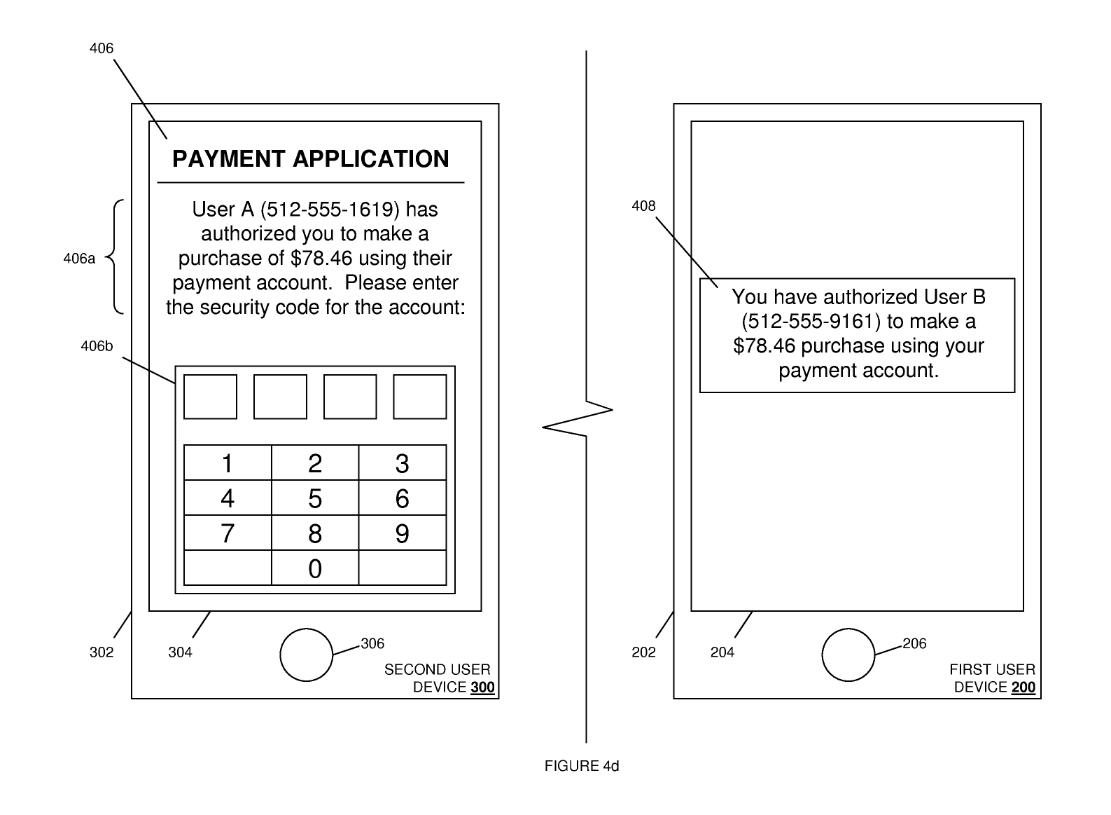

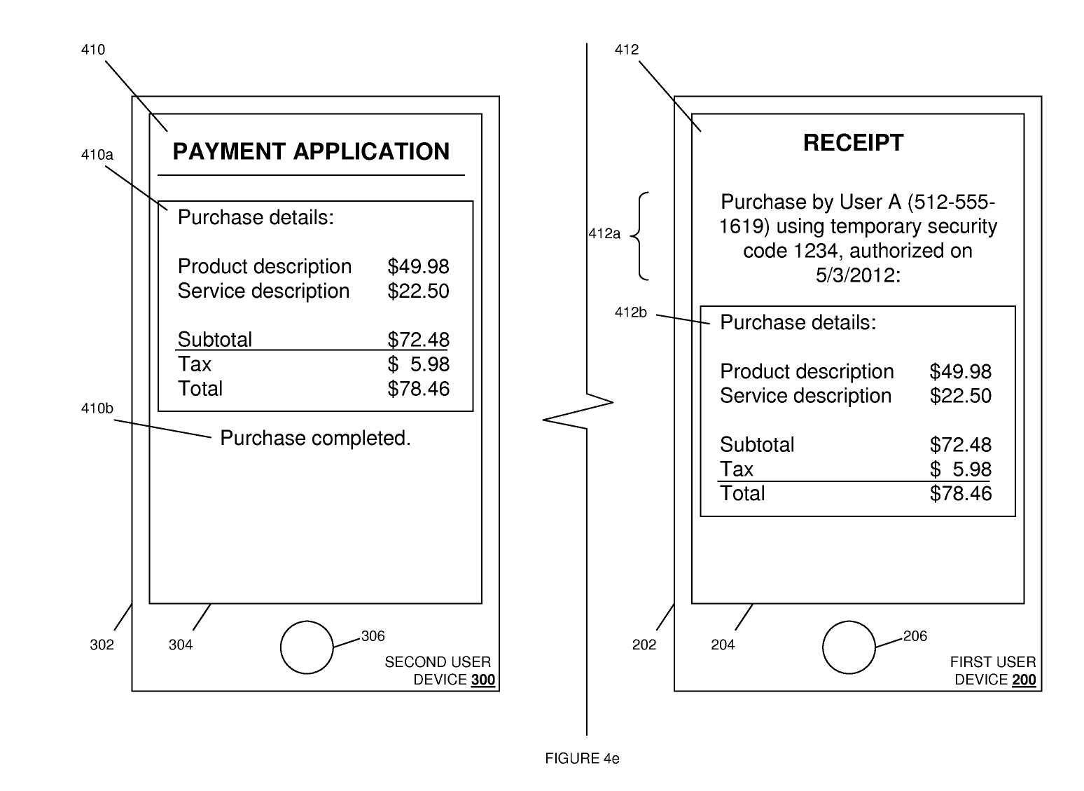

Referring now to FIGS. 1 and 4a, the method 100 may either begin at block 104 or proceed from block 102 to block 104 where a payment request is received from the second user device to make a payment using a payment account associated with the first user device. In the embodiment illustrated in FIG. 4a, the second user device 300 is displaying a payment request page 400 on the display 304 in response to the second user selecting one or more items for purchase.

In an embodiment, the payment request page 400 may be provided as a web page on a website operated by a payee device, an account holder device, a payment provider device, and/or any other payment authorization system provider device. In another embodiment, the payment request page 208 may be provided as an application stored on and operated by the second user device 300. In one example, at block 104, the second user may select one or more items for purchase (through the web page or application), and the second user device 300 is operated to receive the payment request page 400 over a network from the payment authorization system provider device. In another example, the second user may select items for purchase from a payee (e.g., a merchant in a brick-and-motor merchant location) and then present the second user device 300 as a payment device, at which time the payment request page 400 is provided over the network to the second payer device 300 (e.g., as the web page, through the application, etc.)

The payment request page 400 includes a purchase details section 400a that may include the details of the payment request being made such as, for example, descriptions of the items being purchased (e.g., the product description and the service description in the illustrated embodiment), the prices associated with the items being purchased, a subtotal amount of the items being purchased, a tax amount associated with the items being purchased, and a total payment amount for the items being purchased. The payment request page 400 also includes a payment account identifier input 400b that allows the second user of the second user device 300 to provide an identifier for the payment account that the second user would like to use to make the payment for the items being purchased. While not illustrated, one of skill in the art will recognize that the payment request page 400 may include a number of other payment features known in the art which have not been illustrated for clarity of discussion but which would fall within the scope of the present disclosure.

In the illustrated embodiment, the second user has entered the first user device phone number of the first user device 200 in the payment account identifier input 400b in order to make a payment request using the payment account of the first user that is associated with the first user device 200 in a database of the payment authorization system provider. One of skill in the art will recognize that the second user may provide a variety of identifiers (e.g., a payment account number, a first user name, etc.) in the payment account identifier input 400b at block 104 in order to make a payment request using the payment account of the first user. The second user may then use the second user device 300 to submit the payment request (e.g., by selecting a “submit” or “pay” button on the payment request page (not illustrated)) to send the payment request over the network to the payment authorization system provider device.

In some embodiments, the payment authorization system provider device may determine that the payment request needs to be authorized by the first user in response to the payment request being sent from a location that is different from a location of the first user device 200. For example, as described above with reference to FIG. 4a, the second user may user the second user device 300 to make a payment request by providing a payment account identifier (e.g., a payment account number) in the payment account identifier input 400b and sending the payment account identifier input 400b along with the payment request over the network to the payment authorization system provider device. In this embodiment, the second user device 300 may also use a location determination device to determine a current location of the second user device 300, and that current location may then be included in the payment request sent to the payment authorization system provider device. Upon receiving the payment request, the payment authorization system provider device may retrieve, over the network from the first user device 200, a current location of the first user device 200. The payment authorization system provider device may then compare the current location of the first user device 200 to the current location of the second user device 300 to determine whether the payment request is being received from a location that is greater than a predetermined distance from the location of the first user device 200. If the payment request is being received from a location that is greater than the predetermined distance from the first user device 200, the payment authorization system provider device may determine that the payment request is being made from a user device other than that of the first user device 200 and proceed with the method 100, discussed below, to retrieve an authorization from the first user device 200 to use the payment account to satisfy the payment request.

In another example of this embodiment, the second user device 300 may use an Internet Protocol (IP) address determination device to determine an IP address of the second user device 300, and that IP address is included in the payment request sent to the payment authorization system provider device. Upon receiving the payment request, the payment authorization system provider device will either retrieve, over the network from the first user device 200, or look up in a database, an IP address of the first user device 200. The payment authorization system provider device may then compare the IP address of the first user device 200 to the IP address of the second user device 300 to determine whether the payment request is being received from a user device that is not the first user device 200. If the payment request is being received from a user device that is not the first user device 200, the payment authorization system provider device will proceed with the method 100, discussed below, to retrieve an authorization from the first user device 200 to use the payment account to satisfy the payment request.

Thus, some embodiments of the payment authorization system, as discussed in further detail below, may use locations, IP addresses, and/or other user device identifiers as a security feature to determine when payment requests using the payment account are being made from user devices that are not associated with the payment account and, if so, require authorization from the associated first user device before carrying out the payment request.

Referring now to FIGS. 1, 4b, and 4c, the method 100 then proceeds to block 106 where an authorization request is sent to the first user device. Upon receiving the payment request over the network from the second user device 300, the payment authorization system provider device may determine whether the payment account identifier is associated with a user device in a database. As discussed above, the first user device is associated with a payment account in a database of the payment authorization system provider device, and one of skill in the art will recognize that such a database may include associations between a plurality of user devices and any number of payment accounts. Thus, in some embodiments of block 106, the payment authorization system provider device determines that the payment account identifier provided by the second user through the second user device 300 is associated with the first user device 200 and not the second user device 300 in the database and, in response, sends an authorization request to the first user device 200 over the network. In other embodiments of block 106, the sending of the authorization request is performed in response to the determination that the payment account is associated with the first user device 200 and sent from a different location or IP address than the first user device 200, as discussed above. In yet other embodiments, the authorization request is sent in response to determining that the first user device 200 is associated with the payment account and the second user device 300 has only temporarily been associated with the payment account.

In the embodiment illustrated in FIG. 4b, the second user device 300 is still displaying the payment request page 400, but payment authorization system provider device has provided, over the network to the second user device 300, the payment request page 400 with an obtaining authorization section 400c that explains to the second user that the payment account identifier is associated with another user device and an attempt to authorize use of the payment account is being performed. Furthermore, the payment authorization system provider device also provides, over the network to the first user device 200, an authorization request 402 that includes payment request information 402a, along with an authorize button 402b and a deny button 402c. In an embodiment, the authorization request 402 may be provided by a text message, a pop-up window, an alert in an application, a web page, and/or in a variety of other manners known in the art.

In the embodiment illustrated in FIG. 4c, the second user device 300 displays the payment request page 400 with the obtaining authorization section 400c that explains to the second user that the payment account identifier is associated with another user device and an attempt to authorize use of the payment account is being performed. However, in this embodiment, the payment authorization system provider device also provides, over the network to the first user device 200, an authorization request 404 that includes payment request information 404a, along with an authorize pad 404b (e.g., the pin pad in the illustrated embodiment that allows the first user to enter a security code, discussed in further detail below). In an embodiment, the authorization request 404 may be provided by a text message, a pop-up window, an alert in an application, a web page, and/or in a variety of other manners known in the art.

Referring now to FIGS. 1 and 4b, the method 100 proceeds to block 108 where authorization is received from the first user device. In one embodiment, the first user may use the first user device 200 to select the authorization button 402b in order to send an authorization for the second user to use the payment account according to the payment request over the network to the payment authorization system provider device. While additional step are discussed below as being performed by the second user subsequent to the first user sending the authorization using the authorization button 402b, in some embodiments, the authorization sent using the authorization button 402b provides the only authorization needed by the payment authorization system provider device from the first user device 200 in order to allow the second user to use the payment account according to the payment request, discussed in further detail below. Thus, in some embodiments, the first user may use the first user device 200 to authorize the payment request by the second user simply by selecting the authorize button 402b. Furthermore, if the first user does not wish to authorize the payment request by the second user, the first user may select the deny button 402c to send a deny authorization instruction over the network to the payment authorization system provider device, and the payment authorization system provider device will deny the payment request such that the second user cannot use the payment account to purchase the items.

Referring now to FIGS. 1 and 4d, in some embodiments of block 108, following the first user selecting the authorization button 402b in the authorization request 402, the payment authorization system provider device may provide, over the network to the second user device 300, an authorization request 406 that includes an authorization confirmation 406a, along with an authorize pad 406b (e.g., the pin pad in the illustrated embodiment that allows the second user to enter a security code, discussed in further detail below). In an embodiment, the authorization request 406 may be provided by a text message, a pop-up window, an alert in an application, a web page, and/or in a variety of other manners known in the art. Furthermore, as illustrated in FIG. 4d, the payment authorization system provider device may provide, over the network to the first user device 200, an authorization confirmation 408 confirming the authorization of the second user and associated second user device 300 to make a payment according to the payment request using the payment account.

Referring now to FIGS. 1 and 4c, in some embodiments of block 108, the first user may use the first user device 200 to provide an authorization over the network to the payment authorization system provider device by providing a security code in authorize pad 404b. The first user may then use the first user device 200 to send that security code (e.g., by selecting a “submit” button, not illustrated) over the network to the payment authorization system provider device. Thus, in some embodiments, the first user may use the first user device 200 to authorize the payment request by the second user by providing their security code in the first user device 200.

Referring now to FIGS. 1 and 4d, the method 400 may proceed to optional block 110 where a security code is received from the second user device. In some embodiments, after the payment authorization system provider device provides the authorization request 406 to the second user device 300 in response to the first user providing the authorization, the second user may use the second user device 300 to provide a security code (e.g., the security code received in optional block 102 of the method 100) on the second user device 300 by providing a security code in the authorize pad 406b. The second user may then use the second user device 200 to send that security code (e.g., by selecting a “submit” button, not illustrated) over the network to the payment authorization system provider device. Thus, in some embodiments, the first user may use the first user device 200 to authorize the payment request by the second user by selecting the authorize button 402b on the first user device 200, and the second user may then need to provide a previously received security code using the second user device 300 in order allow the payment authorization system provider device to complete the purchase using the payment account.

Referring now to FIGS. 1 and 4e, the method 100 then proceeds to block 112 where an instruction is sent to make a payment according to the payment request. Subsequent to verifying any user devices, security codes, and/or other authorizations discussed above, the payment authorization system provider device may then send instructions to make a payment using the payment account. In an embodiment, the payment authorization system provider device is an account provider device, and the account provider device sends an instruction that results in a payment being made from the payment account to a payee account of a payee which whom the second user was making the purchase from. In another embodiment, the payment authorization system provider device is a payment service provider device, and the payment service provider device sends an instruction to an account provider device that results in a payment being made from the payment account to a payee account of a payee which whom the second user was making the purchase from. Furthermore, the payment authorization system provider device may provide, over the network to the second user device 300, a purchase completed page 410 that includes a purchase details section 410a having the details of the purchase made using the payment account, and a purchase completed indication 410b. Further still, the payment authorization system provider device may provide, over the network to the first user device 200, a receipt page 412 that includes a user device details section 412a that may include information on the second user, the second user device 300, the date the payment was made, and the security code used to authorize the payment request, along with a purchase details section 412b having the details of the purchase made using the payment account.

Thus, a system and method for payment authorization is provided that allows a second user to easily request the use of a first user's payment account, while also allowing the first user to easily authorize the second user to use the payment account. The system and method for payment authorization may be provided with multiple levels of security, ranging from a payment request from the second user and single-click authorization from the first user, to requiring the first user to enter a security code to authorize the payment request, to requiring the second user to enter a previously received security code in response to the first user authorizing the payment request.

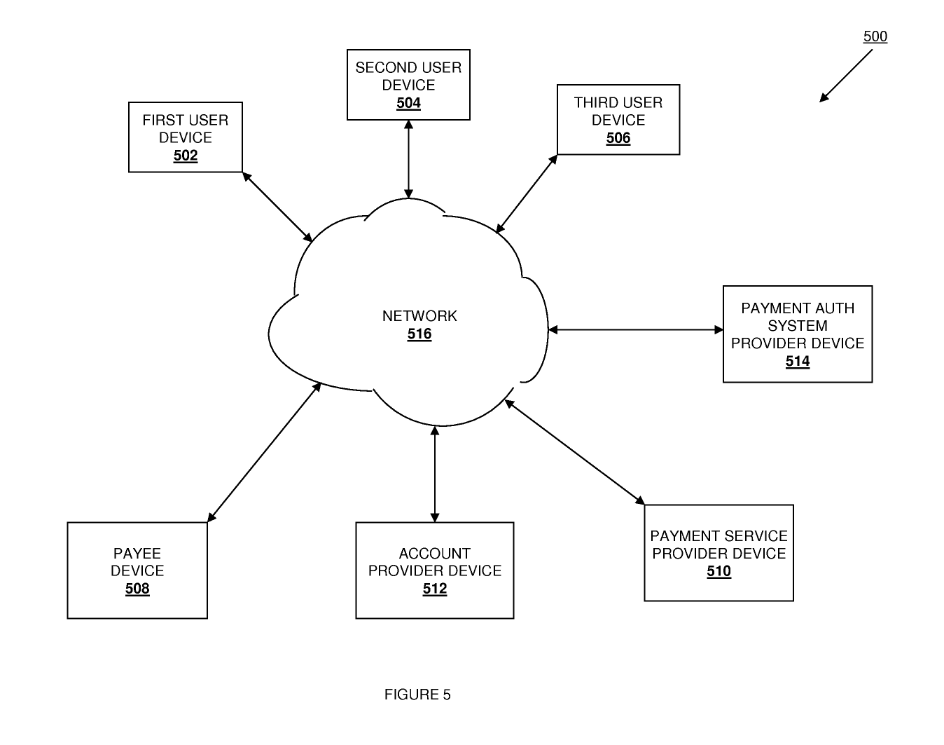

Referring now to FIG. 5, an embodiment of a networked system 500 used in the payment authorization system described above is illustrated. The networked system 500 includes a first user device 502, a second user device 504, a third user device 506, a payee device 508, a payment service provider device 510, an account provider device 512, and/or a payment authorization system provider device 514 in communication over a network 516. The first user devices 502 may be the first user device 200, discussed above, and the second user device 504 and/or the third user device 506 may be the second user device 300, discussed above. The payee device 508 may be the payee device discussed above and may be operated by the payee discussed above. The payment service provider device 510 may be the payment service provider device discussed above and may be operated by a payment service provider such as, for example, PayPal Inc. of San Jose, Calif. The account provider device 512 may be the account provider device discussed above and may be operated by the account providers discussed above such as, for example, credit card account providers, bank account providers, savings account providers, and a variety of other account providers known in the art. The payment authorization system provider device 514 may be the payment authorization system provider device discussed above and may be operated by the payment authorization system provider discussed above.

The first user device 502, second user device 504, third user device 506, payee device 508, payment service provider device 510, account holder device 512, and/or payment authorization system provider device 514 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 500, and/or accessible over the network 516.

The network 516 may be implemented as a single network or a combination of multiple networks. For example, in various embodiments, the network 516 may include the Internet and/or one or more intranets, landline networks, wireless networks, and/or other appropriate types of networks.

The first user device 502, second user device 504, and third user device 506 may be implemented using any appropriate combination of hardware and/or software configured for wired and/or wireless communication over the network 516. For example, in one embodiment, the first user device 502, second user device 504, and third user device 506 may be implemented as a personal computer of a user in communication with the Internet. In other embodiments, the first user device 502, second user device 504, and third user device 506 may be a smart phone, personal digital assistant (PDA), laptop computer, and/or other types of computing devices.

The first user device 502, second user device 504, and third user device 506 may include one or more browser applications which may be used, for example, to provide a convenient interface to permit the user to browse information available over the network 516. For example, in one embodiment, the browser application may be implemented as a web browser configured to view information available over the Internet.

The first user device 502, second user device 504, and third user device 506 may also include one or more toolbar applications which may be used, for example, to provide user-side processing for performing desired tasks in response to operations selected by the user. In one embodiment, the toolbar application may display a user interface in connection with the browser application.

The first user device 502, second user device 504, and third user device 506 may further include other applications as may be desired in particular embodiments to provide desired features to the first user device 502, second user device 504, and third user device 506. In particular, the other applications may include a payment application for payments assisted by a payment service provider through the payment service provider device 510. The other applications may also include security applications for implementing user-side security features, programmatic user applications for interfacing with appropriate application programming interfaces (APIs) over the network 516, or other types of applications. Email and/or text applications may also be included, which allow the user to send and receive emails and/or text messages through the network 516. The first user device 502, second user device 504, and third user device 506 include one or more user and/or device identifiers which may be implemented, for example, as operating system registry entries, cookies associated with the browser application, identifiers associated with hardware of the first user device 502, second user device 504, and third user device 506, or other appropriate identifiers, such as a phone number. In one embodiment, the user identifier may be used by the payment service provider device 510, account provider device 512, and/or payment authorization system provider device 514 to associate the user with a particular account as described herein.

The payee device 508 may be maintained, for example, by a conventional or on-line merchant, conventional or digital goods seller, individual seller, and/or application developer offering various products and/or services in exchange for payment to be received conventionally or over the network 516. In this regard, the payee device 508 may include a database identifying available products and/or services (e.g., collectively referred to as items) which may be made available for viewing and purchase by the users.

The payee device 508 also includes a checkout application which may be configured to facilitate the purchase by the payer of items. The checkout application may be configured to accept payment information from the user through the first user device 502, second user device 504, and third user device 506, the account provider through the account provider device 512, the payment service provider through the payment service provider device 510, and/or the payment authorization system provider through the payment authorization system provider device 514 over the network 516.

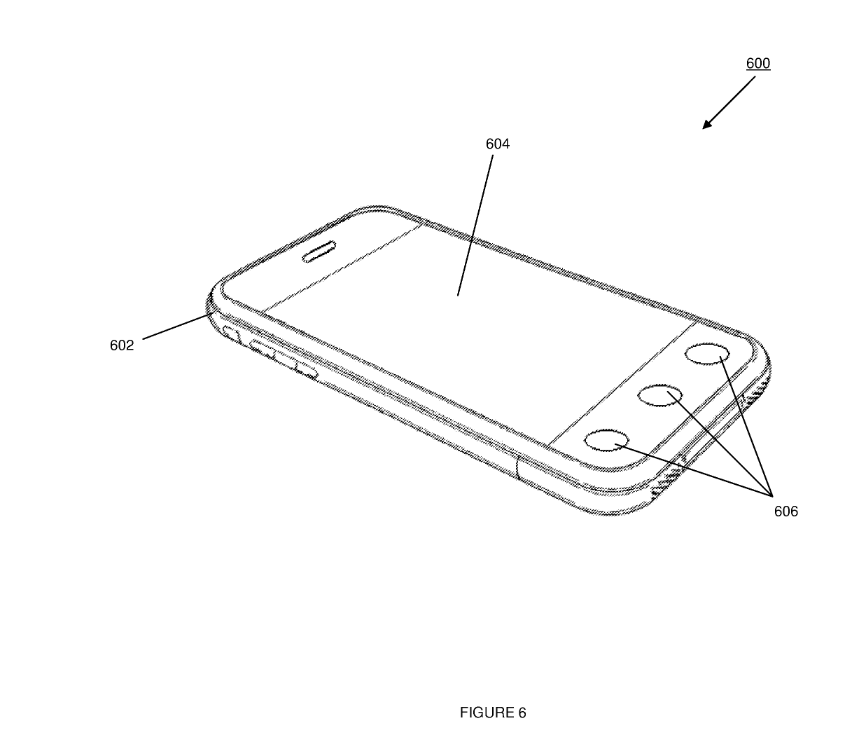

Referring now to FIG. 6, an embodiment of a user device 600 is illustrated. The user device 600 may be the first user devices 200 and/or 502, the second user devices 300 and/or 504, and/or the third user device 506. The user device 600 includes a chassis 602 having a display 604 and an input device including the display 604 and a plurality of input buttons 606. One of skill in the art will recognize that the user device 600 is a portable or mobile phone including a touch screen input device and a plurality of input buttons that allow the functionality discussed above with reference to the method 100. However, a variety of other portable/mobile user devices and/or desktop user devices may be used in the method 100 without departing from the scope of the present disclosure.

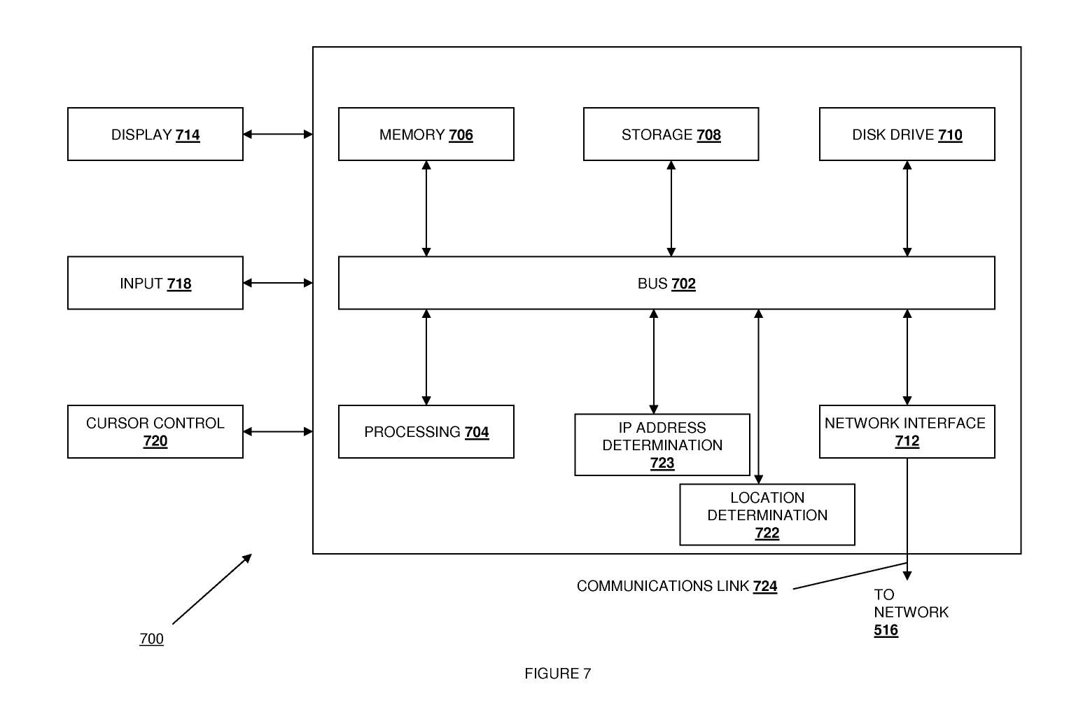

Referring now to FIG. 7, an embodiment of a computer system 700 suitable for implementing, for example, the user device 600 (e.g., first user devices 200 and/or 502, second user devices 300 and/or 504, and/or third user device 506), the payee device 508, the payment service provider device 510, the account holder device 512, and/or the payment authorization system provider device 514, is illustrated. It should be appreciated that other devices utilized by users, payees, payment service providers, account providers, and payment authorization system providers in the payment authorization system discussed above may be implemented as the computer system 700 in a manner as follows.

In accordance with various embodiments of the present disclosure, computer system 700, such as a computer and/or a network server, includes a bus 702 or other communication mechanism for communicating information, which interconnects subsystems and components, such as a processing component 704 (e.g., processor, micro-controller, digital signal processor (DSP), etc.), a system memory component 706 (e.g., RAM), a static storage component 708 (e.g., ROM), a disk drive component 710 (e.g., magnetic or optical), a network interface component 712 (e.g., modem or Ethernet card), a display component 714 (e.g., CRT or LCD), an input component 718 (e.g., keyboard, keypad, or virtual keyboard), a cursor control component 720 (e.g., mouse, pointer, or trackball), a location determination component 722 (e.g., a Global Positioning System (GPS) device as illustrated, a cell tower triangulation device, and/or a variety of other location determination devices known in the art), and/or an IP address determination component 723. In one implementation, the disk drive component 710 may comprise a database having one or more disk drive components.

In accordance with embodiments of the present disclosure, the computer system 700 performs specific operations by the processor 704 executing one or more sequences of instructions contained in the memory component 706, such as described herein with respect to the user device 600 (e.g., first user devices 200 and/or 502, second user devices 300 and/or 504, and/or third user device 506), the payee device 508, the payment service provider device 510, the account holder device 512, and/or the payment authorization system provider device 514. Such instructions may be read into the system memory component 706 from another computer readable medium, such as the static storage component 708 or the disk drive component 710. In other embodiments, hard-wired circuitry may be used in place of or in combination with software instructions to implement the present disclosure.

Logic may be encoded in a computer readable medium, which may refer to any medium that participates in providing instructions to the processor 704 for execution. Such a medium may take many forms, including but not limited to, non-volatile media, volatile media, and transmission media. In many embodiments, the computer readable medium is non-transitory. In various implementations, non-volatile media includes optical or magnetic disks, such as the disk drive component 710, volatile media includes dynamic memory, such as the system memory component 706, and transmission media includes coaxial cables, copper wire, and fiber optics, including wires that comprise the bus 702. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 700. In various other embodiments of the present disclosure, a plurality of the computer systems 700 coupled by a communication link 724 to the network 516 (e.g., such as a LAN, WLAN, PTSN, and/or various other wired or wireless networks, including telecommunications, mobile, and cellular phone networks) may perform instruction sequences to practice the present disclosure in coordination with one another.

The computer system 700 may transmit and receive messages, data, information and instructions, including one or more programs (i.e., application code) through the communication link 724 and the network interface component 712. The network interface component 712 may include an antenna, either separate or integrated, to enable transmission and reception via the communication link 724. Received program code may be executed by processor 704 as received and/or stored in disk drive component 710 or some other non-volatile storage component for execution.

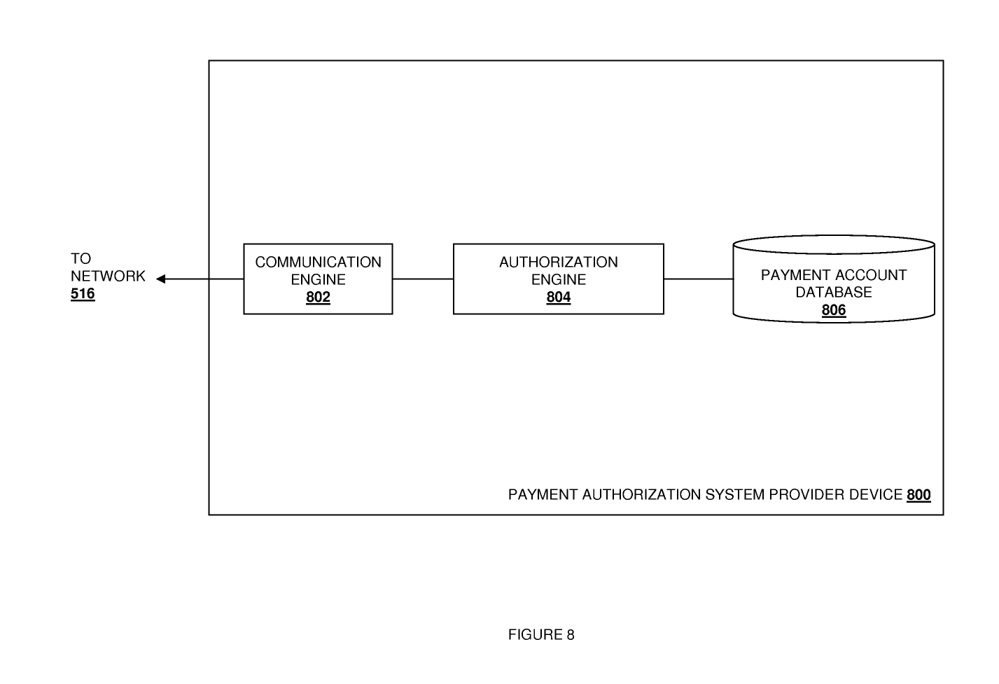

Referring now to FIG. 8, an embodiment of a payment authorization system provider device 800 is illustrated. In an embodiment, the device 800 may be or include the payment service provider device 510 and/or the account holder device 512. The device 800 includes a communication engine 802 that is coupled to the network 516 and to an authorization engine 804 that is coupled to a payment account database 806. The communication engine 802 may be software or instructions stored on a non-transitory, computer-readable medium that allows the device 800 to send and receive information over the network 516. The authorization engine 804 may be software or instructions stored on a non-transitory, computer-readable medium that, when executed by a processor, cause the processor to receive user device designations, associate users devices with payment accounts in the payment account database 806, receive payment requests, compare locations and/or IP addresses of user devices, send authorization requests, receive authorizations, send instructions to make a payment using payment accounts in the payment account database 806, and/or provide any other functionality discussed above with respect to the payment authorization system provider device 800. While the database 806 has been illustrated as located in the payment authorization system provider device 800, one of skill in the art will recognize that it may be connected to the authorization engine 804 through the network 516 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and users; however, a user or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A payment authorization system, comprising:
an account database that includes an association between a first user device and a payment account; and
a system provider device coupled to a network and the account database, wherein the system provider device is operable to:
receive a payment request from a second user device over the network to make a payment using the payment account;
send an authorization request to the first user device over the network in response to receiving the payment request;
receive an authorization from the first user device over the network; and
send an instruction over the network to make a payment according to the payment request in response to receiving the authorization.
